(19) United States
(12) Patent Application Publication
(10) Pub. No.: US 2012/0318146 A1
(43) Pub. Date: Dec. 20, 2012

(54) EXHAUST OXYGEN RECYCLING APPARATUS FOR OZONE TREATMENT EQUIPMENT, AND OZONE-USING SYSTEM HAVING SAME

(75) Inventor: Sung Ah Moon, Hwaseong-si (KR)

(73) Assignee: ARK CO., LTD., Gyeonggi-do (KR)

(21) Appl. No.: 13/512,876

(22) PCT Filed: Nov. 30, 2010
(86) PCT No.: PCT/KR2010/008535

§ 371 Date: Aug. 20, 2012

(30) Foreign Application Priority Data
Nov. 30, 2009 (KR) 10-2009-0116916
Nov. 30, 2010 (KR) 10-2010-0120400

(51) Int. Cl. B01D 53/02; B01D 47/06

(52) U.S. Cl. 96/134; 96/108

(57) ABSTRACT

Disclosed herein is an exhaust oxygen recycling apparatus for ozone treatment equipment, which is used to refine an exhaust oxygenic gas, the exhaust oxygenic gas being discharged to the air after reaction in the ozone treatment equipment, and to recycle the refined oxygenic gas to generate ozone, including: an impurity removing unit for removing impurities from components included in the exhaust gas, the impurities being apt to be recognized as impurities in an ozone generator; and a compressor for compressing the exhaust gas or the exhaust gas refined by the impurity removing unit to a pressure at which the exhaust gas or the refined exhaust gas can be supplied to the ozone generator. The exhaust oxygen recycling apparatus purifies exhaust oxygen, discharged to the air after the reaction that takes place in the ozone treatment equipment, so as to recycle the refined oxygenic gas to generate ozone.

### TECHNICAL FIELD

The present invention relates to an exhaust oxygen recycling apparatus, and, more particularly, to an exhaust oxygen recycling apparatus for ozone treatment equipment, which is used to refine the exhaust oxygen discharged to the air after the reaction in the ozone treatment equipment used to disinfect, remove tastes, smells and colors, reduce organic compounds and perform oxidation of metals such as iron, manganese and the like and to recycle the refined oxygen to generate ozone. Further, the present invention relates to an ozone-using system including the exhaust oxygen recycling apparatus for ozone treatment equipment.

### BACKGROUND ART

Ozone treatment equipment is used in many fields, such as water treatment, digestion tanks, bleaching, sterilization, disinfection, semiconductor equipment systems and the like, for the purpose of removing smells and colors, improving coagulation efficiency, reducing the production of organic chlorine compounds and improving cleanliness and the like.

Meanwhile, organic sludge, such as sewage sludge, excretion sludge or the like, increases every year. However, sludge treatment facilities for incineration or burying sludge are not installed due to local NIMBY phenomena or the like. Further, since discarding sludge into the sea is internationally prohibited, there is no method of suitably disposing of sludge.

Currently, as a method for reducing sludge, anaerobic sludge treatment is generally used. That is, in large-scale sewage disposal plants, sludge is reduced using an anaerobic digestion tank.

FIG. 1 is a schematic view showing an apparatus for reducing sludge using a general anaerobic digestion tank. As shown in FIG. 1, when wastewater is introduced into a primary sedimentation reservoir 110, sludge included in the wastewater settles under gravity and concentrates to form a primary sludge. Meanwhile, a part of the wastewater introduced into the primary sedimentation reservoir 110 is introduced into a secondary sedimentation reservoir 120 via a bioreactor 115 and concentrated to form a secondary sludge.

The primary sludge is introduced into an anaerobic digestion tank 170 through a movement line 135 via a concentration tank 130, and the secondary sludge is introduced into the anaerobic digestion tank 170 through a movement line 145 via a centrifugal concentrator 140 and is then mixed with the primary sludge.

The anaerobic digestion tank 170 is provided with a circulation line 160, one end of which is connected to the lower side of the anaerobic digestion tank 170 and the other end of which is connected to the upper side of the anaerobic digestion tank 170, and the mixed sludge in the anaerobic digestion tank 170 is circulated through the circulation line 160. A steam line 155 is connected to the upper side of the anaerobic digestion tank 170 such that high-temperature steam generated from a boiler 150 is supplied into the anaerobic digestion tank 170 through the steam line 155.

However, the apparatus for reducing sludge is problematic in that it cannot sufficiently reduce sludge because the mixed sludge including the primary and secondary sludge is digested in the anaerobic digestion tank 170 only by an anaerobic digestion process.

Therefore, conventionally, in order to increase the efficiency of reduction of sludge, various methods for easily decomposing sludge in an anaerobic tank by solubilizing organic matter included in the anaerobic tank, such as ultrasonic treatment, ozone treatment, heat treatment and the like, have been used.

FIG. 2 is a process view showing a general digestion system having a solubilization unit (using ozone), and FIG. 3 is a schematic view showing ozone treatment equipment used in the digestion system.

As shown in FIG. 2, the digestion system is provided with a solubilization unit 220 for solubilizing the sludge discharged from an anaerobic digestion tank 210, in which a process of digesting sludge is conducted, using ozone (O₃) or the like and then circulating the solubilized sludge into the anaerobic digestion tank 210, thus increasing the efficiency of reduction of sludge. Here, ozone (O₃) is produced by oxidizing a predetermined amount of oxygen (O₂) having a purity of about 99.9%, which is commercially available from oxygen manufacturing companies, using an ozone generator, and is then supplied to the solubilization unit 220. Further, as shown in FIG. 3, ozone (O₃) is produced by an ozone generator 320 provided at one side of the digestion system, and is then supplied to the solubilization unit 220.

In a general ozone generator, when oxygen having a high purity of 90˜95% or more is supplied, ozone is produced in several steps. In this case, the amount of ozone that is produced is about 10% with respect to the amount of the supplied oxygen. Therefore, ozone discharged from the ozone generator includes oxygen having a purity of 80˜85% or more, so that ozone and oxygen are supplied together to the solubilization unit 220. Meanwhile, ozone supplied to the solubilization unit 220 solubilizes the sludge discharged from the anaerobic digestion tank 210, and is then discharged to the air via an ozone discharge unit. In this case, the exhaust gas discharged to the air includes oxygen (O₂) having a purity of 80˜85% or more as well as CO₂, CH₄, H₂S and the like. That is, conventionally, oxygen (O₂) having a purity of 80˜85% or more is directly discharged to the air.

Meanwhile, even in the fields of water treatment, bleaching, sterilization, disinfection, semiconductor equipment systems and the like, after the sterilization by ozone, oxygen (O₂) having a purity of 80˜85% or more is refined and then discharged to the air together with impurities (impurity gases).

However, the price of the oxygen (O₂) having a purity of about 99.9%, which is commercially available from oxygen manufacturing companies, is about KRW170˜KRW200 (about US$0.17˜US$0.20) per 1 Kg, and, as shown in FIG. 3, even when oxygen is produced by 90˜95% using an oxygen generator 310 of ozone treatment equipment, production costs including a mechanical maintenance cost increase. Meanwhile, in the case where oxygen is produced using the oxygen generator 310 of FIG. 3, air is compressed to 8 bar, the compressed air is processed in several steps to obtain oxygen having a purity of 90˜95%, and then the obtained oxygen is supplied to the ozone generator 320 while being compressed to 2.5˜3 bar.

As described above, conventionally, oxygen purchased or produced at high cost has been mostly discharged to the air, that is, resources have not been sufficiently recycled.

### DISCLOSURE

### Technical Problem

Accordingly, the present invention has been devised to solve the above-mentioned problems, and an object of the present invention is to provide an exhaust oxygen recycling apparatus for ozone treatment equipment, in which an exhaust oxygenic gas being discharged to the air after reaction in the ozone treatment equipment is refined, and then a refined exhaust gas is recycled to generate ozone.

Another object of the present invention is to provide an ozone-using system, in which ozone is generated using the oxygen provided by an exhaust oxygen recycling apparatus for ozone treatment equipment used in the fields of water treatment, digestion tanks, bleaching, sterilization, disinfection, semiconductor equipment systems and the like, and the generated oxygen is self-recycled.

### Technical Solution

In order to accomplish the above objects, an aspect of the present invention provides an exhaust oxygen recycling apparatus for ozone treatment equipment, which is used to refine an exhaust oxygenic gas, the exhaust oxygenic gas being discharged to the air after reaction in the ozone treatment equipment, and to recycle a refined oxygenic gas to generate ozone, comprising: an impurity removing unit for removing impurities from components included in an exhaust gas, the impurities being apt to be recognized as impurities in an ozone generator; and a compressor for compressing the exhaust gas and/or a refined gas to a pressure at which the exhaust gas and/or the refined gas can be supplied to the ozone generator, the refined gas being obtained by removing the impurities from the exhaust gas using the impurity removing unit

In the exhaust oxygen recycling apparatus, the impurity removing unit may remove water, CO₂, CH₄ and N₂ which are apt to be recognized as impurities in the ozone generator. That is, the impurity removing unit may include: a water removing unit for removing water from the exhaust gas by adsorbing water using active alumina and zeolite; a CO₂ and CH₄ removing unit for removing CO₂ and CH₄ from the exhaust gas by adsorbing CO₂ and CH₄ using active carbon; and an N₂ removing unit for removing N₂ from the exhaust gas by adsorbing N₂ using zeolite.

Further, the impurity removing unit may include at least one column-shaped adsorption tower; and the column-shaped adsorption tower may be sequentially charged with active alumina and zeolite used in the water removing unit, active carbon used in the CO₂ and CH₄ removing unit and zeolite used in the N₂ removing unit from a bottom thereof to a top thereof.

Further, the impurity removing unit may further include a H₂S removing unit 410 for removing H₂S from the exhaust gas by injecting water.

Another aspect of the present invention provides an ozone-using system, which is provided with ozone treatment equipment to achieve a predetermined purpose, including the exhaust oxygen recycling apparatus for removing impurities from components included in an exhaust gas being discharged to the air after reaction in the ozone treatment equipment, the impurities being apt to be recognized as impurities in an ozone generator, and then supplying a refined exhaust gas to the ozone generator at a desired pressure.

The ozone-using system may be a water treatment system, a digestion system, a bleaching system, a disinfection system, a sterilization system or a semiconductor equipment system.

Meanwhile, the ozone treatment equipment may include an ozone contactor for bringing raw water into contact with ozone supplied from the ozone generator or may include a solubilization unit for solubilizing sludge discharged from an anaerobic digestion tank using ozone supplied from the ozone generator and then circulating the solubilized sludge into the anaerobic digestion tank.

### Advantageous Effects

The exhaust oxygen recycling apparatus for ozone treatment equipment according to the present invention is advantageous in that an exhaust oxygenic gas being discharged to the air after reaction in the ozone treatment equipment is refined, and then a refined exhaust gas is recycled to generate ozone.

The ozone-using system according to the present invention is advantageous in that ozone is generated using the oxygen provided by an exhaust oxygen recycling apparatus for ozone treatment equipment used in the fields of water treatment, digestion tanks, bleaching, sterilization, disinfection, semiconductor equipment systems and the like, and the generated oxygen is self-recycled. That is, when the ozone-using system is applied to a digestion system, it serves to improve the efficiency of reduction of sludge, when it is applied to a water treatment system, it serves to improve the taste of water, and when it is applied to a semiconductor equipment system, it serves to improve the cleanliness of the semiconductor.

### DESCRIPTION OF DRAWINGS

FIG. 1 is a schematic view showing an apparatus for reducing sludge using a general anaerobic digestion tank;

FIG. 2 is a process view showing a general digestion system having a solubilization unit (using ozone);

FIG. 3 is a schematic view showing ozone treatment equipment used in the digestion system;

FIG. 4 is a block diagram showing an exhaust oxygen recycling apparatus for ozone treatment equipment according to an embodiment of the present invention;

FIG. 5 is a detail view showing an exhaust oxygen recycling apparatus for ozone treatment equipment according to an embodiment of the present invention;

FIG. 6 is a block diagram showing a process of removing impurities in the exhaust oxygen recycling apparatus for ozone treatment equipment shown in FIG. 5;

FIG. 7 is a block diagram showing a digestion system including the exhaust oxygen recycling apparatus for ozone treatment equipment according to an embodiment of the present invention;

FIG. 8 is a process view showing a digestion system including the exhaust oxygen recycling apparatus for ozone treatment equipment according to an embodiment of the present invention; and

FIG. 9 is a block diagram showing a water treatment system including the exhaust oxygen recycling apparatus for ozone treatment equipment according to another embodiment of the present invention.

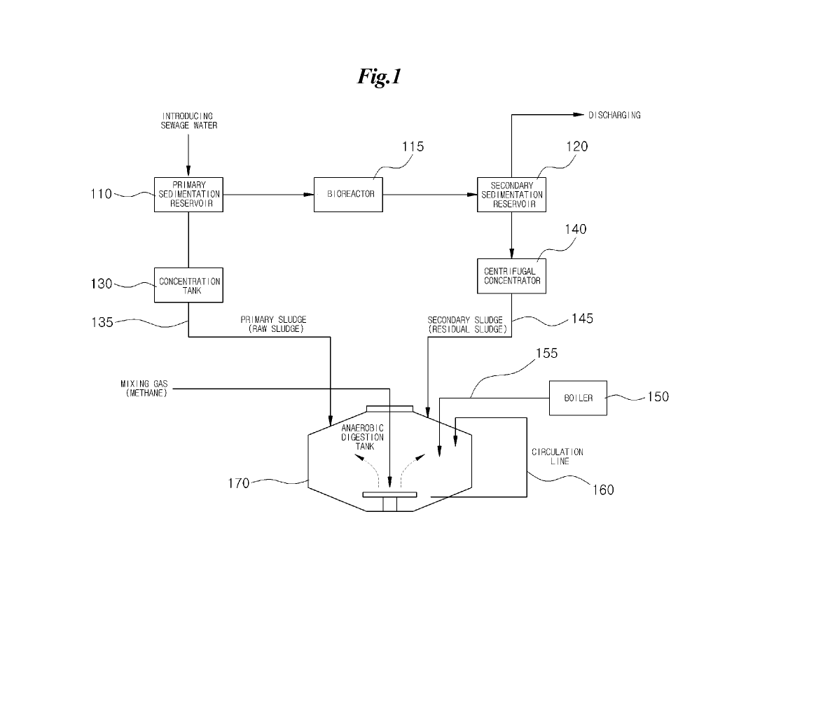

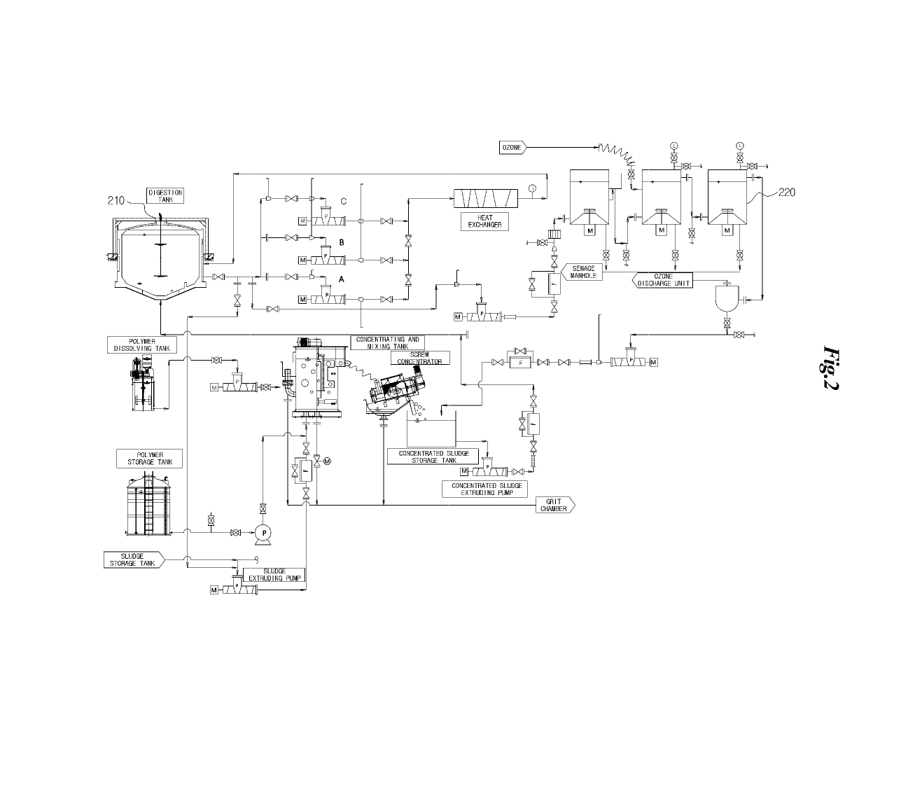

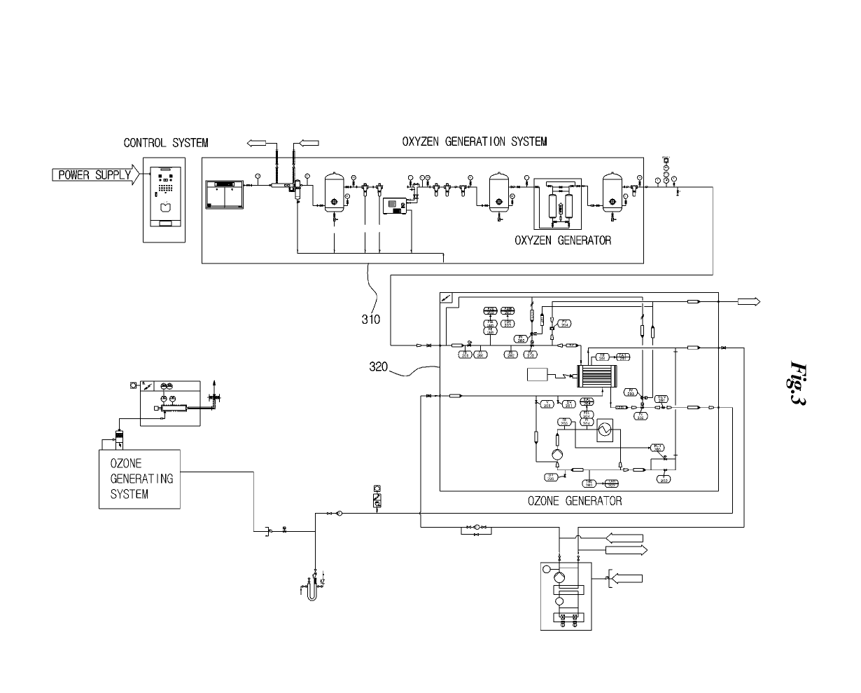

### BEST MODE

Hereinafter, preferred embodiments of the present invention will be described in detail with reference to the accompanying drawings.

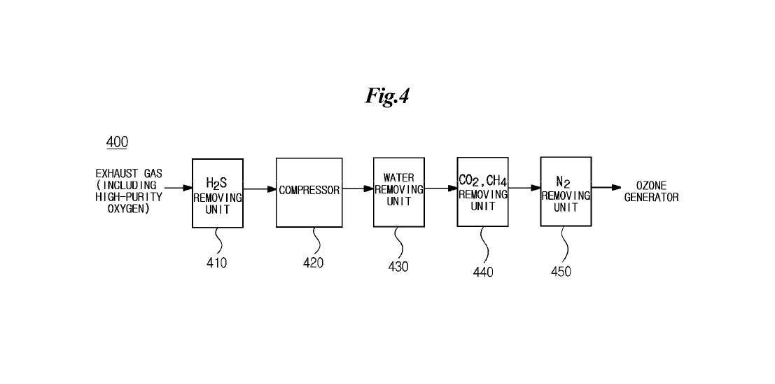

FIG. 4 is a block diagram showing an exhaust oxygen recycling apparatus for ozone treatment equipment according to an embodiment of the present invention. Ozone treatment equipment is used in many fields, such as water treatment, digestion tanks, bleaching, sterilization, disinfection, semiconductor equipment systems and the like, for the purpose of removal of smells and colors, improvement of coagulation efficiency, reduction of the production of organic chlorine compounds, improvement of cleanliness and the like. As shown in FIG. 4, the exhaust oxygen recycling apparatus 400 for ozone treatment equipment according to this embodiment, which is used to refine an exhaust oxygenic gas, the exhaust oxygenic gas being discharged to the air after reaction in the ozone treatment equipment, and to recycle a refined oxygenic gas to generate ozone, includes: a compressor 420 for compressing exhaust gas to a pressure at which the exhaust gas can be supplied to an ozone generator; and an impurity removing unit for removing water and impurities (including impurity gases) from the exhaust gas.

Here, the components included in the exhaust gas change depending on the application field (for example, a water treatment system, a digestion system or the like) in which the ozone treatment equipment is used. For example, when ozone treatment equipment is applied to a digestion system, the exhaust gas includes O₂, O₂, N₂, CO₂, CH₄, H₂S and the like.

The impurity removing unit serves to remove water, N₂, CO₂, CH₄, H₂S and the like excluding O₃ and O₂ which are not apt to be recognized as impurities in an ozone generator. In the impurity removing unit, H₂S is removed by injecting water, water is removed by adsorbing it using active alumina, zeolite or the like, N₂ is removed by adsorbing it using zeolite or the like, and CO₂ and CH₄ are removed by adsorbing them using active carbon or the like.

Therefore, the impurity removing unit includes: a H₂S removing unit 410 for removing H₂S from exhaust gas by injecting water; a water removing unit 430 for removing water from exhaust gas by adsorbing water using active alumina and zeolite; a CO₂ and CH₄ removing unit 440 for removing CO₂ and CH₄ from exhaust gas by adsorbing CO₂ and CH₄ using active carbon; and an N₂ removing unit 450 for removing N₂ from exhaust gas by adsorbing N₂ using zeolite.

The exhaust oxygen recycling apparatus 400 for ozone treatment equipment according to this embodiment, the constituents of which carry out the above-mentioned functions, respectively, is configured such that an H₂S removing unit 410, the compressor 420, the water removing unit 430, the CO₂ and CH₄ removing unit 440 and the N₂ removing unit 450 are sequentially provided from upstream to downstream. Meanwhile, the water removing unit 430, the CO₂ and CH₄ removing unit 440 and the N₂ removing unit 450 may be provided in one column to conduct their respective functions. Here, the reason why the compressor 420 is provided upstream of the CO₂ and CH₄ removing unit 440 and the N₂ removing unit 450 is because CO₂, CH₄ and N₂ can be removed more efficiently when they are compressed.

Meanwhile, when ozone treatment equipment is applied to a water treatment system, exhaust gas may include N₂, CO₂, CH₄, chloride components and the like which are apt to be recognized as impurities in an ozone generator as well as O₃ and O₂ which are not apt to be recognized as impurities. Therefore, the impurity removing unit may be configured such that N₂, CO₂, CH₄, chloride components and the like can be removed. That is, the impurity removing unit according to this embodiment may be configured such that all of the impurities included in the exhaust gas can be removed in accordance with the application field of ozone treatment equipment.

The water removing unit 430 serves to remove the water injected to remove H₂S or the water self-included in the exhaust gas in accordance with the application field of ozone treatment equipment, and the compressor 420 is used to compress the exhaust gas to a pressure at which the exhaust gas can be supplied to an ozone generator. A general ozone generator generates ozone using oxygen compressed to a pressure of 2.5˜3 bar. The compressor 420 of this embodiment may compress the exhaust gas to a pressure of 3.5˜4 bar in consideration of the pressure loss in the removing units 430, 440 and 450 upstream of the ozone generator such that the refined exhaust gas is supplied to the ozone generator while being compressed to a pressure of 2.5˜3 bar. However, the compressor 420 may also compress the exhaust gas to a pressure of less than 2.5 bar or more than 3 bar in accordance with the specifications of the ozone generator.

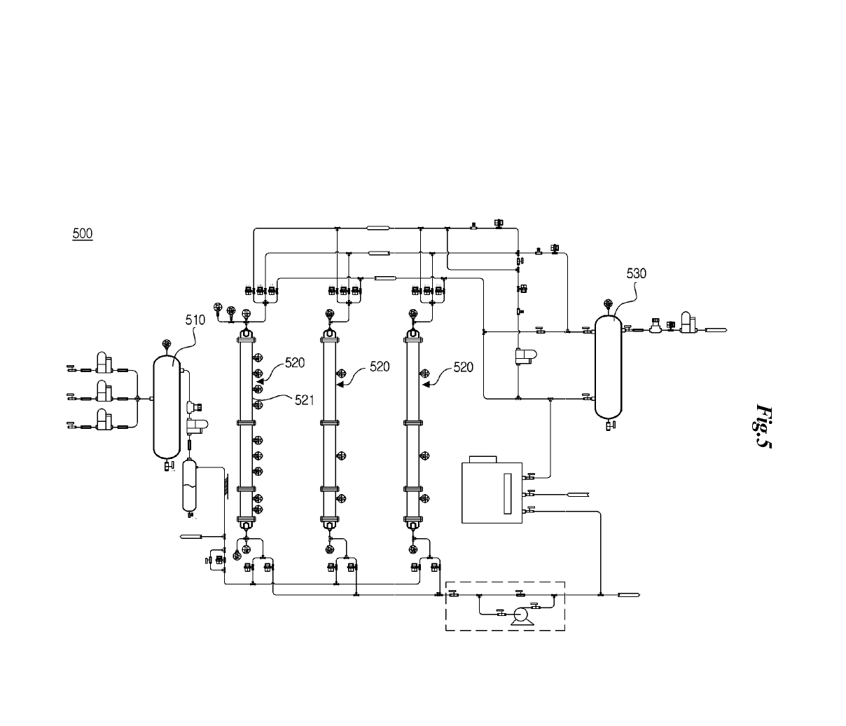

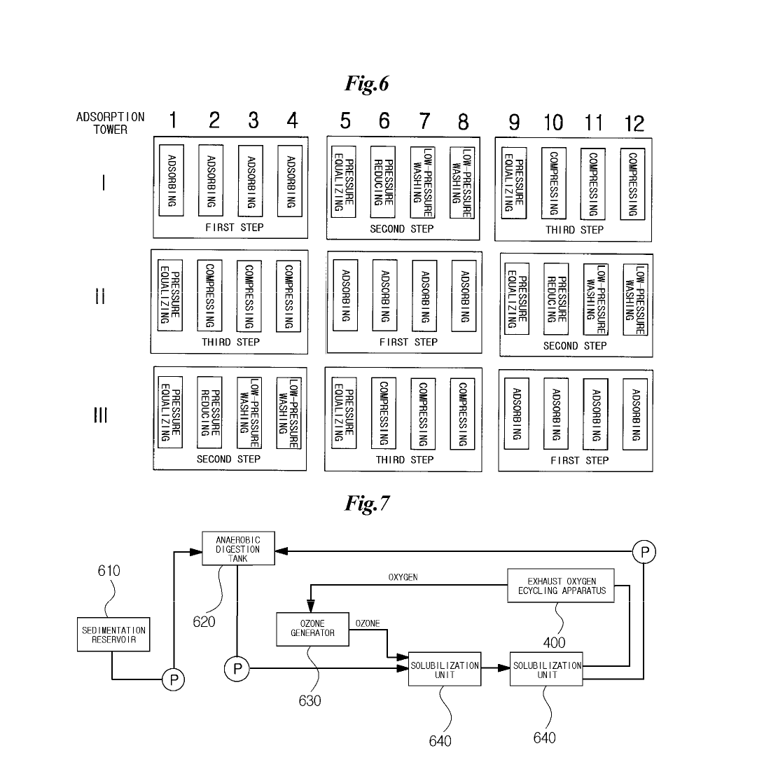

FIG. 5 is a detail view showing an exhaust oxygen recycling apparatus for ozone treatment equipment according to an embodiment of the present invention, and FIG. 6 is a block diagram showing a process of removing impurities in the exhaust oxygen recycling apparatus for ozone treatment equipment shown in FIG. 5. As shown in FIG. 5, the exhaust oxygen recycling apparatus 500 for ozone treatment equipment according to this embodiment includes: an exhaust gas supply tank 510 for compressing exhaust gas (including O₃, O₂, N₂, CO₂, CH₄ and water), which is discharged after the reaction in ozone treatment equipment to a pressure at which the exhaust gas can be supplied to an ozone generator, and then storing the compressed exhaust gas; a plurality of impurity removing units 520 for removing water and impurities (including impurity gases) from the compressed exhaust gas supplied from the exhaust gas supply tank 510; a refined exhaust gas storage tank 530 for storing O₃ and O₂ remaining in the exhaust gas from which water and impurities were removed by the plurality of impurity removing units 520; and a control unit (not shown) for controlling the constituents.

Each of the impurity removing units 520 according to this embodiment includes a column-shaped adsorption tower 521 and a plurality of control valves. The adsorption tower 521 is filled with adsorbents for adsorbing and removing CO₂, CH₄ N₂ and the like. For example, alumina and zeolite 4A for adsorbing and removing water, active carbon for adsorbing and removing CO₂ and CH₄, and zeolite 13X for adsorbing and removing N₂ may be sequentially charged in the adsorption tower 521 from the bottom thereof to the top thereof. Here, the amount of each of the adsorbents charged in the adsorption tower 521 may be determined depending on the components of the exhaust gas discharged after the reaction that takes place in the ozone treatment equipment. Further, the kinds of the adsorbents charged in the adsorption tower 521 may also be determined depending on the components of the exhaust gas discharged after the reaction in the ozone treatment equipment. That is, the kinds and amounts of the adsorbents charged in the adsorption tower 521 may be varied depending on the ozone-using system provided with the ozone treatment equipment.

When impurities are adsorbed and removed using the exhaust oxygen recycling apparatus 500, as shown in FIG. 6, the exhaust oxygen recycling apparatus 500 may be configured such that twelve processes are carried out in each adsorption tower 521. That is, the method of removing impurities in each adsorption tower 521 largely includes three steps. Specifically, in the first step, four adsorbing processes are performed, in the second step, a pressure equalizing process, a pressure reducing process and two low-pressure washing processes are performed, and in the third step, a pressure equalizing process and three compressing processes are performed. In addition, each of the adsorption towers may be configured such that impurities are adsorbed and removed by simultaneously performing different steps.

### MODE FOR INVENTION

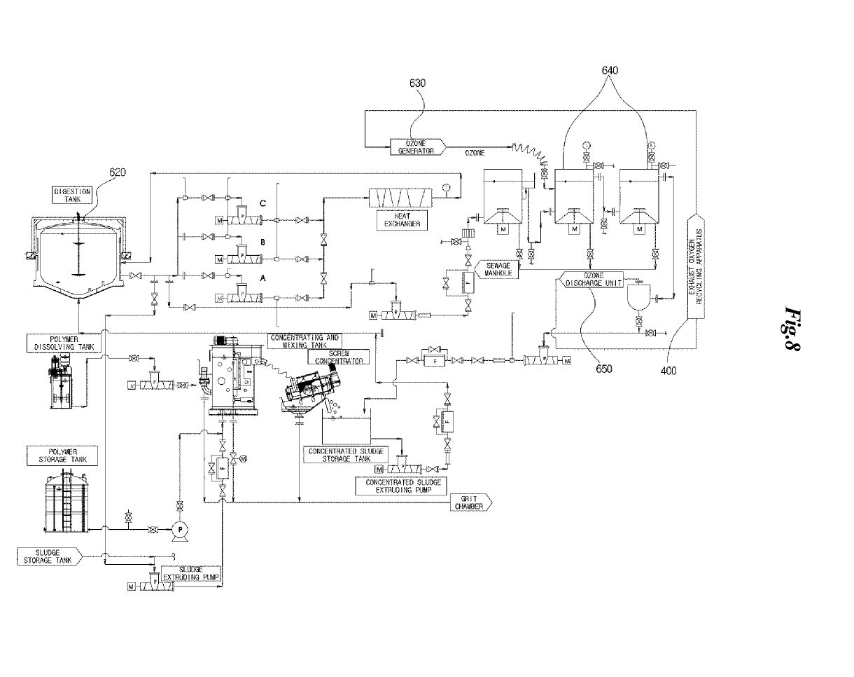

FIG. 7 is a block diagram showing a digestion system including the exhaust oxygen recycling apparatus for ozone treatment equipment according to an embodiment of the present invention. As shown in FIGS. 4 and 7, the digestion system according to this embodiment includes: an anaerobic digestion tank 620 in which a process of digesting the concentrated sludge discharged from a sedimentation reservoir 610 is conducted; a solubilization unit 640 for solubilizing the sludge discharged from the anaerobic digestion tank 20 using ozone supplied from an ozone generator 630 and then circulating the solubilized sludge into the anaerobic digestion tank 620; and an exhaust oxygen recycling apparatus 400 for removing CO₂, CH₄, H₂S, and N₂ from the exhaust gas discharged from the solubilization unit 640, the exhaust gas including O₃, O₂, N₂, CO₂, CH₄, H₂S and water, excluding O₃ and O₂ which are not apt to be recognized as impurities in the ozone generator 630, and then supplying the refined exhaust gas to the ozone generator 630 at desired pressure.

FIG. 8 is a process view showing the digestion system including the exhaust oxygen recycling apparatus for ozone treatment equipment according to this embodiment. The digestion system according to this embodiment is configured such that the exhaust gas discharged from the solubilization unit 640 and then discharged to the air via the ozone discharge unit 650 is recovered into the rear end of the ozone discharge unit 650, and the recovered exhaust gas is refined by removing impurities, such as water, CO₂, CH₄, H₂S and N₂, therefrom in the exhaust oxygen recycling apparatus 400, and then the refined exhaust gas including ozone (O₃) and high-purity oxygen (O₂) is supplied to the ozone generator 630 to produce ozone, thereby recycling the exhaust gas. Therefore, this digestion system has the advantage of efficiently recycling resources.

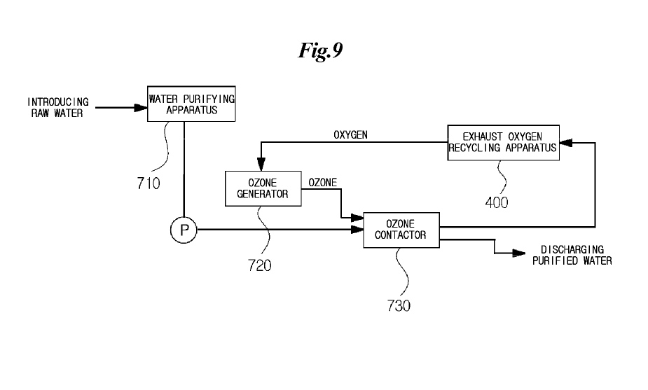

FIG. 9 is a block diagram showing a water treatment system including the exhaust oxygen recycling apparatus for ozone treatment equipment according to another embodiment of the present invention. As shown in FIGS. 4 and 9, the water treatment system according to this embodiment includes: a water refining apparatus 710 for primarily refining raw water; an ozone contactor 730 for bringing the primarily refined water into contact with ozone supplied from an ozone generator 720 to remove green algae and the like and to improve the taste of water; and an exhaust oxygen recycling apparatus 400 for removing CO₂, CH₄, H₂S, and N₂ from the exhaust gas discharged from the ozone contactor 730, the exhaust gas including O₃, O₂, N₂, CO₂, CH₄, H₂S and water, excluding O₃ and O₂ which are not apt to be recognized as impurities in the ozone generator 720, and then supplying the refined exhaust gas to the ozone generator 720 at the desired pressure.

As described above, preferred embodiments of the present invention are set forth to illustrate the present invention, and the scope of the present invention is not limited thereto.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

### INDUSTRIAL APPLICABILITY

When the exhaust oxygen recycling apparatus for ozone treatment equipment according to the present invention is used in the fields of water treatment, digestion tanks, bleaching, sterilization, disinfection, semiconductor equipment systems and the like, ozone is generated using the oxygen provided by the exhaust oxygen recycling apparatus, and the generated oxygen can be self-recycled.

What is claimed is:

1. An exhaust oxygen recycling apparatus for ozone treatment equipment, which is used to refine an exhaust oxygenic gas, the exhaust oxygenic gas being discharged to the air after reaction in the ozone treatment equipment, and to recycle a refined oxygenic gas to generate ozone, comprising:
an impurity removing unit for removing impurities from components included in an exhaust gas, the impurities being apt to be recognized as impurities in an ozone generator; and
a compressor for compressing the exhaust gas and/or a refined gas to a pressure at which the exhaust gas and/or the refined gas can be supplied to the ozone generator, the refined gas being obtained by removing the impurities from the exhaust gas using the impurity removing unit.

2. The exhaust oxygen recycling apparatus of claim 1, wherein the impurity removing unit removes water, CO₂, CH₄ and N₂ which are apt to be recognized as impurities in the ozone generator.

3. The exhaust oxygen recycling apparatus of claim 2, wherein the impurity removing unit comprises: a water removing unit for removing water from the exhaust gas by adsorbing water using active alumina and zeolite; a CO₂ and CH₄ removing unit for removing CO₂ and CH₄ from the exhaust gas by adsorbing CO₂ and CH₄ using active carbon; and an N₂ removing unit for removing N₂ from the exhaust gas by adsorbing N₂ using zeolite.

4. The exhaust oxygen recycling apparatus of claim 3, wherein the impurity removing unit includes at least one column-shaped adsorption tower; and the column-shaped adsorption tower is sequentially charged with active alumina and zeolite used in the water removing unit, active carbon used in the CO₂ and CH₄ removing unit and zeolite used in the N₂ removing unit from a bottom thereof to a top thereof.

5. The exhaust oxygen recycling apparatus of claim 3, wherein the impurity removing unit further comprises an H₂S removing unit for removing H₂S from the exhaust gas by injecting water.

6. An ozone-using system, which is provided with ozone treatment equipment to achieve a predetermined purpose, comprising the exhaust oxygen recycling apparatus of claim 1, wherein the exhaust oxygen recycling apparatus removes impurities from components included in an exhaust gas being discharged to the air after reaction in the ozone treatment equipment, the impurities being apt to be recognized as impurities in an ozone generator, and then supplies a refined exhaust gas to the ozone generator at a desired pressure.

7. The ozone-using system of claim 6, wherein the ozone-using system is a water treatment system, a digestion system, a bleaching system, a disinfection system, a sterilization system or a semiconductor equipment system.

8. The ozone-using system of claim 6, wherein the ozone treatment equipment comprises an ozone contactor for bringing raw water into contact with ozone supplied from the ozone generator.

9. The ozone-using system of claim 6, wherein the ozone treatment equipment comprises a solubilization unit for solubilizing sludge discharged from an anaerobic digestion tank using ozone supplied from the ozone generator and then circulating the solubilized sludge into the anaerobic digestion tank.

10. An ozone-using system, which is provided with ozone treatment equipment to achieve a predetermined purpose, comprising the exhaust oxygen recycling apparatus of claim 2, wherein the exhaust oxygen recycling apparatus removes impurities from components included in an exhaust gas being discharged to the air after reaction in the ozone treatment equipment, the impurities being apt to be recognized as impurities in an ozone generator, and then supplies a refined exhaust gas to the ozone generator at a desired pressure.

11. The ozone-using system of claim 10, wherein the ozone-using system is a water treatment system, a digestion system, a bleaching system, a disinfection system, a sterilization system or a semiconductor equipment system.

12. The ozone-using system of claim 10, wherein the ozone treatment equipment comprises an ozone contactor for bringing raw water into contact with ozone supplied from the ozone generator.

13. The ozone-using system of claim 10, wherein the ozone treatment equipment comprises a solubilization unit for solubilizing sludge discharged from an anaerobic digestion tank using ozone supplied from the ozone generator and then circulating the solubilized sludge into the anaerobic digestion tank.

14. An ozone-using system, which is provided with ozone treatment equipment to achieve a predetermined purpose, comprising the exhaust oxygen recycling apparatus of claim 3, wherein the exhaust oxygen recycling apparatus removes impurities from components included in an exhaust gas being discharged to the air after reaction in the ozone treatment equipment, the impurities being apt to be recognized as impurities in an ozone generator, and then supplies a refined exhaust gas to the ozone generator at a desired pressure.

15. The ozone-using system of claim 14, wherein the ozone-using system is a water treatment system, a digestion system, a bleaching system, a disinfection system, a sterilization system or a semiconductor equipment system.

16. The ozone-using system of claim 14, wherein the ozone treatment equipment comprises an ozone contactor for bringing raw water into contact with ozone supplied from the ozone generator.

17. The ozone-using system of claim 14, wherein the ozone treatment equipment comprises a solubilization unit for solubilizing sludge discharged from an anaerobic digestion tank using ozone supplied from the ozone generator and then circulating the solubilized sludge into the anaerobic digestion tank.

18. An ozone-using system, which is provided with ozone treatment equipment to achieve a predetermined purpose, comprising the exhaust oxygen recycling apparatus of claim 4, wherein the exhaust oxygen recycling apparatus removes impurities from components included in an exhaust gas being discharged to the air after reaction in the ozone treatment equipment, the impurities being apt to be recognized as impurities in an ozone generator, and then supplies a refined exhaust gas to the ozone generator at a desired pressure.

19. The ozone-using system of claim 18, wherein the ozone-using system is a water treatment system, a digestion system, a bleaching system, a disinfection system, a sterilization system or a semiconductor equipment system.

20. The ozone-using system of claim 18, wherein the ozone treatment equipment comprises an ozone contactor for bringing raw water into contact with ozone supplied from the ozone generator.

21. The ozone-using system of claim 18, wherein the ozone treatment equipment comprises a solubilization unit for solubilizing sludge discharged from an anaerobic digestion tank using ozone supplied from the ozone generator and then circulating the solubilized sludge into the anaerobic digestion tank.

22. An ozone-using system, which is provided with ozone treatment equipment to achieve a predetermined purpose, comprising the exhaust oxygen recycling apparatus of claim 5, wherein the exhaust oxygen recycling apparatus removes impurities from components included in an exhaust gas being discharged to the air after reaction in the ozone treatment equipment, the impurities being apt to be recognized as impurities in an ozone generator, and then supplies a refined exhaust gas to the ozone generator at a desired pressure.

23. The ozone-using system of claim 22, wherein the ozone-using system is a water treatment system, a digestion system, a bleaching system, a disinfection system, a sterilization system or a semiconductor equipment system.

24. The ozone-using system of claim 22, wherein the ozone treatment equipment comprises an ozone contactor for bringing raw water into contact with ozone supplied from the ozone generator.

25. The ozone-using system of claim 22, wherein the ozone treatment equipment comprises a solubilization unit for solubilizing sludge discharged from an anaerobic digestion tank using ozone supplied from the ozone generator and then circulating the solubilized sludge into the anaerobic digestion tank.
